(19) United States
(12) Patent Application Publication
(10) Pub. No.: US 2022/0398217 A1
(43) Pub. Date: Dec. 15, 2022

(54) System and Method for Snapshot Rule Time Zone Value

(71) Applicant: EMC IP Holding Company, LLC, Hopkinton, MA (US)

(72) Inventors: Lee M. McColgan, Brattleboro, VT (US); Pradyumna K. Revur, Hopkinton, MA (US); Qi Jin, Sudbury, MA (US)

(21) Appl. No.: 17/344,284

(22) Filed: Jun. 10, 2021

(51) Int. Cl. G06F 16/11; G06F 16/16; G06F 11/14

(52) U.S. Cl. CPC G06F 16/128; G06F 16/122; G06F 16/168; G06F 11/1461

(57) ABSTRACT

A method, computer program product, and computing system receiving a snapshot rule associated with a storage array from a first user with a first time zone value via a computing device. A snapshot rule associated with the storage array may be received from a second user with a second time zone value via a computing device. The first time zone value, the second time zone value, and a time zone value associated with a physical location of the storage array may all be different. The snapshot rule of the first user and the snapshot rule of the second user may be executed in response to receiving the snapshot rule associated with the storage array from the second user with a second time zone value.

### TECHNICAL FIELD

This disclosure relates to a snapshot rule and, more particularly, to a snapshot rule time zone value addition.

### BACKGROUND

Storing and safeguarding electronic content is of paramount importance in modern business. Accordingly, various methodologies may be employed to protect such electronic content. Examples of such methodologies may include the repeated generation of backup copies of the data (in the form of snapshots) that may be stored remotely on a storage array, wherein these backup copies may be utilized to rebuild any data that is lost/corrupted in the event of, for example, a system failure. However, if a storage array is located in a different time zone than each of the users, each user may desire to schedule a snapshot (i.e., a snapshot rule) to be taken at a time set for their specific time zone.

### SUMMARY OF DISCLOSURE

In one implementation, a computer-implemented method may include receiving a snapshot rule associated with a storage array from a first user with a first time zone value via a computing device. A snapshot rule associated with the storage array may be received from a second user with a second time zone value via a computing device. The first time zone value, the second time zone value, and a time zone value associated with a physical location of the storage array may all be different. The snapshot rule of the first user and the snapshot rule of the second user may be executed in response to receiving the snapshot rule associated with the storage array from the second user with a second time zone value.

One or more of the following may be included. Executing the snapshot rule of the first user may be configured to account for a transition to daylight savings time in the first time zone value during the execution of the snapshot rule. Executing the snapshot rule of the first user may be configured to account for a transition from daylight savings time in the first time zone value during the execution of the snapshot rule. The first time zone value and/or the second time zone value may be chosen from a time zone database. The time zone database may be kept up-to-date. The first time zone value may be a default value set based on a physical location of a client device associated with the first user. The default time zone may be modified, via a client device associated with the first user, before executing the snapshot rule associated with the first user. The first time zone value associated with the first user may be modified. The modified first time zone value may be displayed, via a graphical user interface of the client device associated with the first user, to the first user. The modified first time zone value may be different from a time zone of a physical location of a client device associated with the first user.

In another implementation, a computer program product resides on a computer readable medium that has a plurality of instructions stored on it. When executed by a processor, the instructions cause the processor to perform operations including receiving a snapshot rule associated with a storage array from a first user with a first time zone value via a computing device. A snapshot rule associated with the storage array may be received from a second user with a second time zone value via a computing device. The first time zone value, the second time zone value, and a time zone value associated with a physical location of the storage array may all be different. The snapshot rule of the first user and the snapshot rule of the second user may be executed in response to receiving the snapshot rule associated with the storage array from the second user with a second time zone value.

One or more of the following may be included. Executing the snapshot rule of the first user may be configured to account for a transition to daylight savings time in the first time zone value during the execution of the snapshot rule. Executing the snapshot rule of the first user may be configured to account for a transition from daylight savings time in the first time zone value during the execution of the snapshot rule. The first time zone value and/or the second time zone value may be chosen from a time zone database. The time zone database may be kept up-to-date. The first time zone value may be a default value set based on a physical location of a client device associated with the first user. The default time zone may be modified, via a client device associated with the first user, before executing the snapshot rule associated with the first user. The first time zone value associated with the first user may be modified. The modified first time zone value may be displayed, via a graphical user interface of the client device associated with the first user, to the first user. The modified first time zone value may be different from a time zone of a physical location of a client device associated with the first user.

In another implementation, a computing system includes a memory and a processor, wherein the processor is configured to perform operations including receiving a snapshot rule associated with a storage array from a first user with a first time zone value via a computing device. A snapshot rule associated with the storage array may be received from a second user with a second time zone value via a computing device. The first time zone value, the second time zone value, and a time zone value associated with a physical location of the storage array may all be different. The snapshot rule of the first user and the snapshot rule of the second user may be executed in response to receiving the snapshot rule associated with the storage array from the second user with a second time zone value.

One or more of the following may be included. Executing the snapshot rule of the first user may be configured to account for a transition to daylight savings time in the first time zone value during the execution of the snapshot rule. Executing the snapshot rule of the first user may be configured to account for a transition from daylight savings time in the first time zone value during the execution of the snapshot rule. The first time zone value and/or the second time zone value may be chosen from a time zone database. The time zone database may be kept up-to-date. The first time zone value may be a default value set based on a physical location of a client device associated with the first user. The processor may be further configured to modify the default time zone, via a client device associated with the first user, before executing the snapshot rule associated with the first user. The processor may be even further configured to modify the first time zone value associated with the first user. The modified first time zone value may be displayed to the first user. The modified first time zone value may be different from a time zone of a physical location of a client device associated with the first user.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is an example diagrammatic view of a storage system and a time zone value addition process coupled to an example distributed computing network according to one or more example implementations of the disclosure;

FIG. 2 is an example diagrammatic view of a storage system of FIG. 1 according to one or more example implementations of the disclosure;

FIG. 3 is an example diagrammatic view of a storage target of FIG. 1 according to one or more example implementations of the disclosure;

FIG. 4 is an example flowchart of a time zone value addition process according to one or more example implementations of the disclosure;

FIG. 5 is an example diagrammatic view of a time zone value addition according to one or more example implementations of the disclosure;

FIG. 6 is an example diagrammatic view of a time zone value addition according to one or more example implementations of the disclosure;

FIG. 7 is an example diagrammatic view of a time zone value addition according to one or more example implementations of the disclosure; and

FIG. 8 is an example diagrammatic view of a time zone value addition according to one or more example implementations of the disclosure.

Like reference symbols in the various drawings indicate like elements.

### DETAILED DESCRIPTION OF THE PREFERRED EMBODIMENTS

### System Overview:

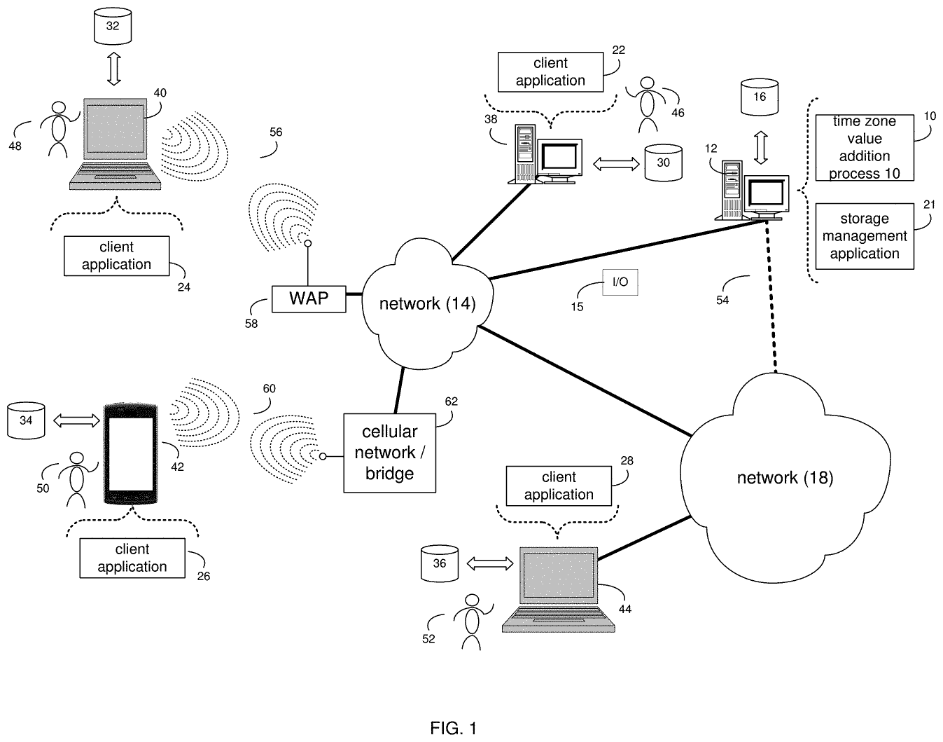

Referring to FIG. 1, there is shown time zone value addition process 10 (that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a mini computer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of time zone value addition process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random access memory (RAM); a read-only memory (ROM); and all forms of flash memory storage devices. Additionally/alternatively, some portions of the instruction sets and subroutines of time zone value addition process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g. IO request 20) may be sent from client applications 22, 24, 26, 28 to storage system 12. Examples of TI request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### Data Storage System:

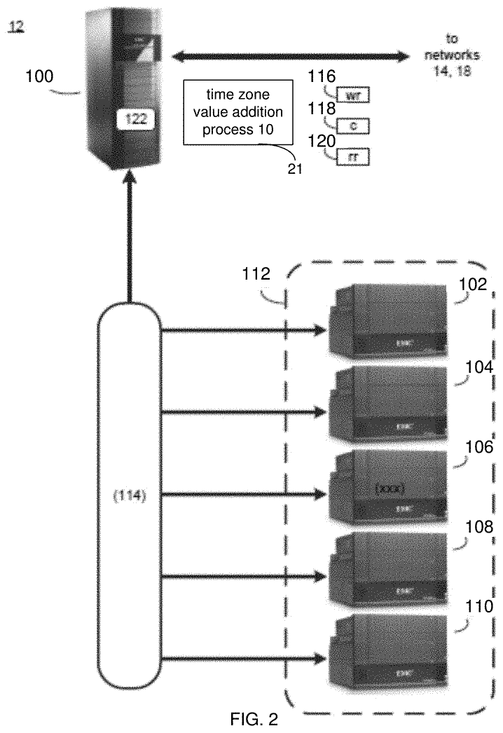

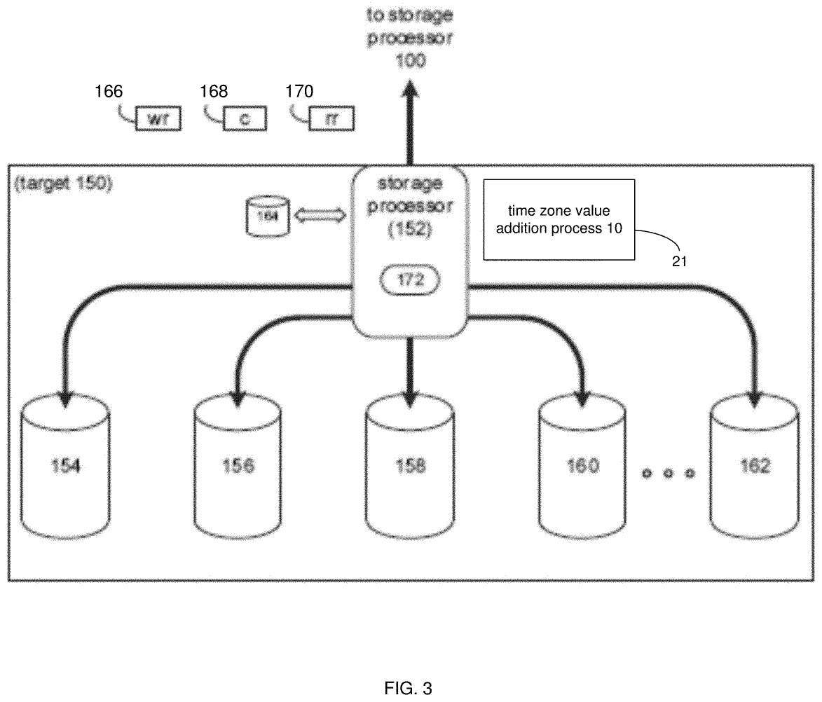

Referring also to the example implementation of FIGS. 2-3 (e.g., where computer 12 may be configured as a data storage system), computer 12 may include storage processor 100 and a plurality of storage targets (e.g., storage targets 102, 104, 106, 108, 110). In some implementations, storage targets 102, 104, 106, 108, 110 may include any of the above-noted storage devices. In some implementations, storage targets 102, 104, 106, 108, 110 may be configured to provide various levels of performance and/or high availability. For example, storage targets 102, 104, 106, 108, 110 may be configured to form a non-fully-duplicative fault-tolerant data storage system (such as a non-fully-duplicative RAID data storage system), examples of which may include but are not limited to: RAID 3 arrays, RAID 4 arrays, RAID 5 arrays, and/or RAID 6 arrays. It will be appreciated that various other types of RAID arrays may be used without departing from the scope of the present disclosure.

While in this particular example, computer 12 is shown to include five storage targets (e.g., storage targets 102, 104, 106, 108, 110), this is for example purposes only and is not intended limit the present disclosure. For instance, the actual number of storage targets may be increased or decreased depending upon, e.g., the level of redundancy/performance/capacity required.

Further, the storage targets (e.g., storage targets 102, 104, 106, 108, 110) included with computer 12 may be configured to form a plurality of discrete storage arrays. For instance, and assuming for example purposes only that computer 12 includes, e.g., ten discrete storage targets, a first five targets (of the ten storage targets) may be configured to form a first RAID array and a second five targets (of the ten storage targets) may be configured to form a second RAID array.

In some implementations, one or more of storage targets 102, 104, 106, 108, 110 may be configured to store coded data (e.g., via storage management process 21), wherein such coded data may allow for the regeneration of data lost/corrupted on one or more of storage targets 102, 104, 106, 108, 110. Examples of such coded data may include but is not limited to parity data and Reed-Solomon data. Such coded data may be distributed across all of storage targets 102, 104, 106, 108, 110 or may be stored within a specific storage target.

Examples of storage targets 102, 104, 106, 108, 110 may include one or more data arrays, wherein a combination of storage targets 102, 104, 106, 108, 110 (and any processing/control systems associated with storage management application 21) may form data array 112 (otherwise referred to as “storage array 112”).

The manner in which computer 12 is implemented may vary depending upon e.g., the level of redundancy/performance/capacity required. For example, computer 12 may be configured as a SAN (i.e., a Storage Area Network), in which storage processor 100 may be, e.g., a dedicated computing system and each of storage targets 102, 104, 106, 108, 110 may be a RAID device. An example of storage processor 100 may include but is not limited to a VPLEX™, VNX™, TRIDENT™, or Unity™ system offered by Dell EMC™ Hopkinton, Mass.

In the example where computer 12 is configured as a SAN, the various components of computer 12 (e.g., storage processor 100, and storage targets 102, 104, 106, 108, 110) may be coupled using network infrastructure 114, examples of which may include but are not limited to an Ethernet (e.g., Layer 2 or Layer 3) network, a fiber channel network, an InfiniBand network, or any other circuit switched/packet switched network.

As discussed above, various I/O requests (e.g., I/O request 15) may be generated. For example, these I/O requests may be sent from, e.g., client applications 22, 24, 26, 28 to, e.g., computer 12. Additionally/alternatively (e.g., when storage processor 100 is configured as an application server or otherwise), these I/O requests may be internally generated within storage processor 100 (e.g., via storage management process 21). Examples of I/O request 15 may include but are not limited to data write request 116 (e.g., a request that content 118 be written to computer 12) and data read request 120 (e.g., a request that content 118 be read from computer 12).

In some implementations, during operation of storage processor 100, content 118 to be written to computer 12 may be received and/or processed by storage processor 100 (e.g., via storage management process 21). Additionally/alternatively (e.g., when storage processor 100 is configured as an application server or otherwise), content 118 to be written to computer 12 may be internally generated by storage processor 100 (e.g., via storage management process 21).

As discussed above, the instruction sets and subroutines of storage management application 21, which may be stored on storage device 16 included within computer 12, may be executed by one or more processors and one or more memory architectures included with computer 12. Accordingly, in addition to being executed on storage processor 100, some or all of the instruction sets and subroutines of storage management application 21 (and/or time zone value addition process 10) may be executed by one or more processors and one or more memory architectures included with data array 112.

In some implementations, storage processor 100 may include front end cache memory system 122. Examples of front end cache memory system 122 may include but are not limited to a volatile, solid-state, cache memory system (e.g., a dynamic RAM cache memory system), a non-volatile, solid-state, cache memory system (e.g., a flash-based, cache memory system), and/or any of the above-noted storage devices.

In some implementations, storage processor 100 may initially store content 118 within front end cache memory system 122. Depending upon the manner in which front end cache memory system 122 is configured, storage processor 100 (e.g., via storage management process 21) may immediately write content 118 to data array 112 (e.g., if front end cache memory system 122 is configured as a write-through cache) or may subsequently write content 118 to data array 112 (e.g., if front end cache memory system 122 is configured as a write-back cache).

In some implementations, one or more of storage targets 102, 104, 106, 108, 110 may include a backend cache memory system. Examples of the backend cache memory system may include but are not limited to a volatile, solid-state, cache memory system (e.g., a dynamic RAM cache memory system), a non-volatile, solid-state, cache memory system (e.g., a flash-based, cache memory system), and/or any of the above-noted storage devices.

### Storage Targets:

As discussed above, one or more of storage targets 102, 104, 106, 108, 110 may be a RAID device. For instance, and referring also to FIG. 3, there is shown example target 150, wherein target 150 may be one example implementation of a RAID implementation of, e.g., storage target 102, storage target 104, storage target 106, storage target 108, and/or storage target 110. An example of target 150 may include but is not limited to a VPLEX™, TRIDENT™, or Unity™system offered by Dell EMC™ of Hopkinton, Mass. Examples of storage devices 154, 156, 158, 160, 162 may include one or more electro-mechanical hard disk drives, one or more solid-state/flash devices, and/or any of the above-noted storage devices. It will be appreciated that while the term “disk” or “drive” may be used throughout, these may refer to and be used interchangeably with any types of appropriate storage devices as the context and functionality of the storage device permits.

In some implementations, target 150 may include storage processor 152 and a plurality of storage devices (e.g., storage devices 154, 156, 158, 160, 162). Storage devices 154, 156, 158, 160, 162 may be configured to provide various levels of performance and/or high availability (e.g., via storage management process 21). For example, one or more of storage devices 154, 156, 158, 160, 162 (or any of the above-noted storage devices) may be configured as a RAID 0 array, in which data is striped across storage devices. By striping data across a plurality of storage devices, improved performance may be realized. However, RAID 0 arrays may not provide a level of high availability. Accordingly, one or more of storage devices 154, 156, 158, 160, 162 (or any of the above-noted storage devices) may be configured as a RAID 1 array, in which data is mirrored between storage devices. By mirroring data between storage devices, a level of high availability may be achieved as multiple copies of the data may be stored within storage devices 154, 156, 158, 160, 162.

While storage devices 154, 156, 158, 160, 162 are discussed above as being configured in a RAID 0 or RAID 1 array, this is for example purposes only and not intended to limit the present disclosure, as other configurations are possible. For example, storage devices 154, 156, 158, 160, 162 may be configured as a RAID 3, RAID 4, RAID 5 or RAID 6 array.

While in this particular example, target 150 is shown to include five storage devices (e.g., storage devices 154, 156, 158, 160, 162), this is for example purposes only and not intended to limit the present disclosure. For instance, the actual number of storage devices may be increased or decreased depending upon, e.g., the level of redundancy/performance/capacity required.

In some implementations, one or more of storage devices 154, 156, 158, 160, 162 may be configured to store (e.g., via storage management process 21) coded data, wherein such coded data may allow for the regeneration of data lost/corrupted on one or more of storage devices 154, 156, 158, 160, 162. Examples of such coded data may include but are not limited to parity data and Reed-Solomon data. Such coded data may be distributed across all of storage devices 154, 156, 158, 160, 162 or may be stored within a specific storage device.

The manner in which target 150 is implemented may vary depending upon e.g., the level of redundancy/performance/capacity required. For example, target 150 may be a RAID device in which storage processor 152 is a RAID controller card and storage devices 154, 156, 158, 160, 162 are individual “hot-swappable” hard disk drives. Another example of target 150 may be a RAID system, examples of which may include but are not limited to an NAS (i.e., Network Attached Storage) device or a SAN (i.e., Storage Area Network).

In some implementations, storage target 150 may execute all or a portion of storage management application 21. The instruction sets and subroutines of storage management application 21, which may be stored on a storage device (e.g., storage device 164) coupled to storage processor 152, may be executed by one or more processors and one or more memory architectures included with storage processor 152. Storage device 164 may include but is not limited to any of the above-noted storage devices.

As discussed above, computer 12 may be configured as a SAN, wherein storage processor 100 may be a dedicated computing system and each of storage targets 102, 104, 106, 108, 110 may be a RAID device. Accordingly, when storage processor 100 processes data requests 116, 120, storage processor 100 (e.g., via storage management process 21) may provide the appropriate requests/content (e.g., write request 166, content 168 and read request 170) to, e.g., storage target 150 (which is representative of storage targets 102, 104, 106, 108 and/or 110).

In some implementations, during operation of storage processor 152, content 168 to be written to target 150 may be processed by storage processor 152 (e.g., via storage management process 21). Storage processor 152 may include cache memory system 172. Examples of cache memory system 172 may include but are not limited to a volatile, solid-state, cache memory system (e.g., a dynamic RAM cache memory system) and/or a non-volatile, solid-state, cache memory system (e.g., a flash-based, cache memory system). During operation of storage processor 152, content 168 to be written to target 150 may be received by storage processor 152 (e.g., via storage management process 21) and initially stored (e.g., via storage management process 21) within front end cache memory system 172.

### The Snapshot Process:

As mentioned above, with regards to storing data in to preemptively prepare for the possibility of a system failure (e.g., a restart, power disruption, etc.), repeated generation of backup copies of the data (in the form of snapshots) may be stored remotely on a storage array (e.g., storage array 112), wherein these backup copies may be utilized to rebuild any data that is lost/corrupted. The storage array (e.g., storage array 112) itself may locally include various resources such as volumes, volume groups, NAS filesystems, and virtual machines.

As is known in the art, a “snapshot” of a data structure is a temporal copy of the data included within the data structure. Such “snapshots” may be stored for later use to e.g. restore files accidentally deleted and/or recover from a hardware failure. Further, snapshots may be scheduled using a snapshot rules via a scheduler. A snapshot rule may include a specific time of day value and then be executed. The time of day value may be set by a user. The scheduler may be a time of day scheduler where a user may specify a single time value within a 24-hour clock when a user wants a snapshot to be taken. Further, a user may specify one or more days of the week the snapshot is to be taken and/or on an interval basis. For example, a user may specify a snapshot be taken every five minutes, every fifteen minutes, etc.

In regards to storing snapshots on the storage array (e.g., storage array 112), the storage array (e.g., storage array 112) may need to be configured to account for multiple users within different time zones. The time zone value may represent a value of a region of the globe that observes a uniform standard time. For example, if a storage array (e.g., storage array 112) is located in a different time zone than each user, each user may desire to schedule a daily and/or nightly snapshot to be taken at a time set for their specific time zone. In the event of a system failure of, for example and not to be construed as a limitation, a user's system, a user may desire to recover data from the storage array (e.g., storage array 112) where the storage array (e.g., storage array 112) may contain separate copies of each of the user's data. For instance, a storage array (e.g., storage array 112) may be located in the United States, while a first user may be located in Europe and a second user may be located in South Asia. The first user and the second user may each desire to set separate snapshot rules to be executed at different times of the day from one another using the scheduler. As such, a “locality” problem may occur where physical resources (e.g., resources of the storage array) may be shared by personnel around the world. Therefore, even though the physical resource (e.g., storage array 112) may have a locality where it is installed, the personnel using it likely perceive its locality as their own. However, when the storage array (e.g., storage array 112) is available via the cloud and/or Storage-as-a-Service (STaaS), a user may be unaware and unable to determine the physical location of the resource (e.g., storage array 112). While a variety of solutions my exist to address this challenging, the existing approaches are only understood as to allow for only one time zone to be configured on a storage array which each user must follow the set time zone of the storage array.

With regards to scheduling a daily and/or nightly snapshot, the location of the storage array becomes a critical component of ensuring the snapshots are taken at the desired time of a user. While a snapshot rule may allow for conversion between the time zone of the user and the time zone of the storage array where the time zone of the storage array may be stored in Coordinated Universal Time (UTC). However, when the user's time zone is converted to the time zone of the storage array, a challenge may arise in accounting for daylight savings time (DST). For example, adoption of DST may vary widely across the world, with different dates of observance. Further, DST observance details may change every few years, such as, for example, counties stopping observing DST all together. As such, failure of a snapshot rule to correctly handle DST may result in a shift of one hour for the schedule snapshot(s), which may have a severe impact on a user's ability to accurately capture a snapshot of the user's system. For example, the storage array (e.g., storage array 112) may be physically located in Boston, Mass. (i.e., “Eastern Time” (ET) or UTC-05:00). Continuing with the example, a user may, on Jul. 12, 2020, create a time-of-day snapshot for every night at 9:00 PM ET using a graphical user interface (GUI). The selected time for the snapshot to occur (e.g., 9:00 ET) may be converted to UTC and stored on the storage array (e.g., storage array 112). As such, all time values entered into the storage array may be presumed to be in UTC time. Therefore, the storage array (e.g., storage array 112) may not have the ability to maintain a time zone value of a user and, as such, a user may not have a way of entering/selecting the user's time zone, which may lead to the storage array (e.g., storage array 112) not being able to account for DST. While the snapshot rule may function as desired by the user (i.e., snapshots may be created every night at 9:00 PM ET), the snapshot rule will not function properly once DST occurs on Nov. 1, 2020, at 2 AM ET when the time is rolled back by one hour. Specifically, the snapshot rule will not function properly because the time for the snapshot rule was stored in UTC, which may cause the snapshot rule to be executed at 8:00 PM instead of 9:00 PM.

### The Time Zone Value Addition Process:

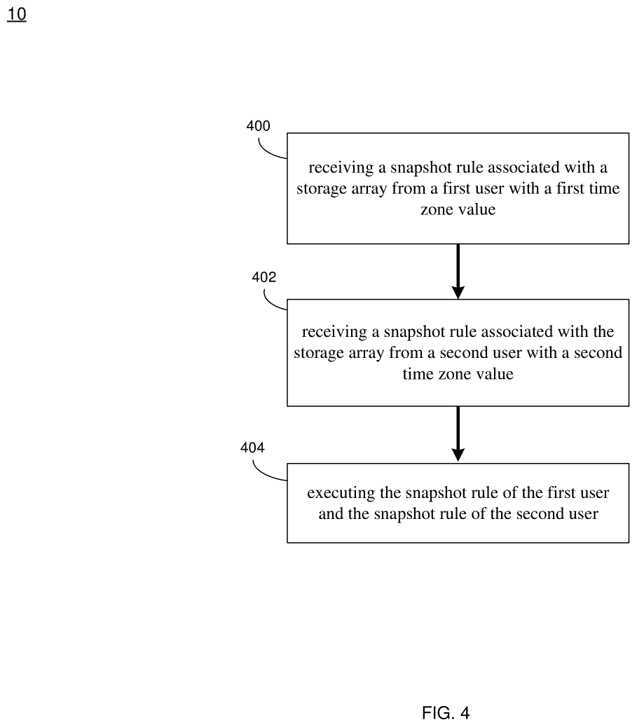

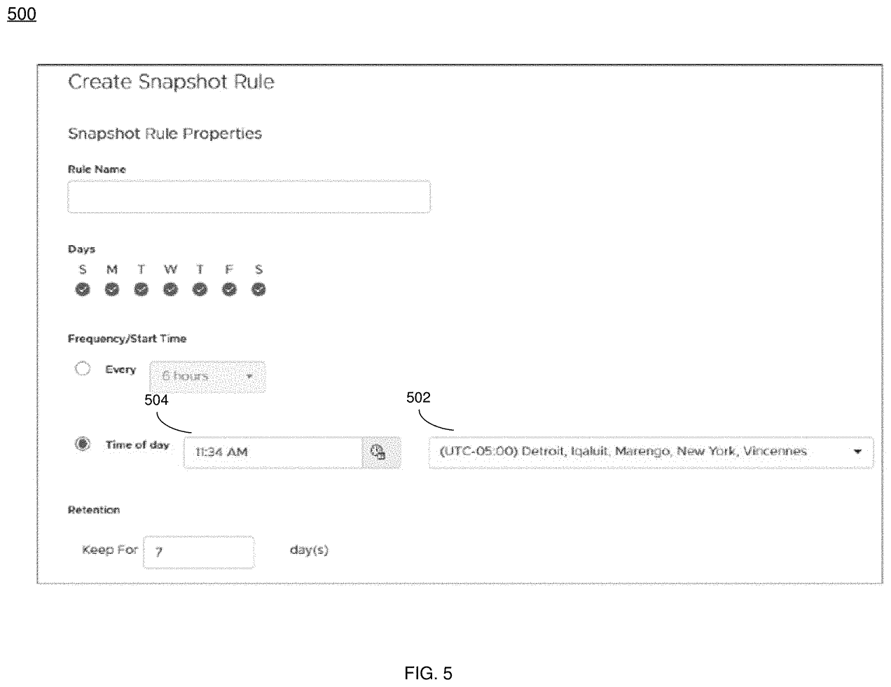

Referring to FIGS. 4-8, embodiments according to the present disclosure of time zone value addition process 10 are shown. In light of the above noted challenges regarding accounting for a user's time zone in a snapshot rule (e.g. snapshot rule, 500), time zone value addition process 10 may allow a user to specify the user's time zone (e.g., first time zone value 502) when creating or editing a snapshot to allow for proper handling of the user's time zone. As such, multiple users (i.e., tenants) of a storage array may create a snapshot rule (e.g., 500) that follows each user's specific time zone rule.

In some embodiments, a snapshot rule (e.g., snapshot rule 500) associated with a storage array (e.g., storage array 112) from a first user with a first time zone value (e.g., first time zone value 502) may be received 400 via a computing device. A snapshot rule (e.g., snapshot rule 500) associated with the storage array (e.g., storage array 112) from a second user with a second time zone value may be received 402 via the computing device. Further, the first time zone value (e.g., 502), the second time zone value, and a time zone value associated with a physical location of the storage array (e.g., storage array 112) all may be different. For example, the first time zone value (e.g., first time zone value 502) may be set to reflect the time zone of New York (UTC), the second time zone value may be set in Greenwich Mean Time (GMT), and the time zone of the storage array may be in ET. Both time zone values (e.g., first time zone value 502) may be persisted with the snapshot rule (e.g., snapshot rule 500). In other words, the first time zone value (e.g., first time zone value 502) may be persisted with the snapshot rule (e.g., snapshot rule 500) in the storage array (e.g., storage array 112), specifically a management database of the storage array (e.g., storage array 112).

In some embodiments, the snapshot rule (e.g., snapshot rule 500) of the first user may be executed 404 in response to receiving the snapshot rule (e.g., snapshot rule 500) associated with the storage array (e.g., storage array 112) from the second user with a second time zone value. Further, the snapshot rule of the second user may be executed 404 in response to receiving the snapshot rule associated with the storage array (e.g., storage array 112) from the second user with a second time zone value. In some embodiments, a snapshot rule (e.g., snapshot rule 500) associated with the storage array (e.g., storage array 112) may be received 400 from a first user with a first time zone value (e.g., first time zone value 502) and a first time of day value (e.g., first time of day value 504). The time of day value (e.g., time of day value 504) may be stored in the snapshot rule associated with the first user. As a result, the first time zone value (e.g., first time zone value 502) and the time of day value (e.g., time of day value 504) may be stored in the snapshot rule.

In some embodiments, a snapshot rule associated with the storage array (e.g., storage array 112) may be received 400 from a second user with a second time zone value and a second time of day value. The time of day value (e.g., time of day value 504) may be stored in the snapshot rule associated with the second user. As a result, the first time zone value (e.g., first time zone value 502) and the time of day value (e.g., time of day value 504) may be stored in the snapshot rule.

In some embodiments, executing the snapshot rule (e.g., snapshot rule 500) of the first user may be able to account for a transition to or from DST in the first user's time zone during the execution of the snapshot rule. As such, the snapshot will always be taken at a same time, even during a transition to or from DST in the first user's time zone.

In some embodiments, executing the snapshot rule of the second user may be able to account for a transition to or from DST in the second user's time zone during the execution of the snapshot rule (e.g., snapshot rule 500). As such, the snapshot will always be taken at a same time, even during a transition to or from DST in the second user's time zone.

In some embodiments, the first time zone value (e.g., first time zone value 502) and the second time zone value may be selected from a time zone value database. The time zone value database may be in the form of a time zone list when displayed via a GUI associated with a client device of a user in a drop-down menu format. Table 1 below provides an example of various time zones supported using an Application Programing Interface (API):

TABLE 1

| timezone | TimeZoneEnum string |
|---|---|
| | Default: UTC |
| | Example: America/New_York |
| | Description: Time zone identifier for applying the time zone to the time_of_day for |
| | a snapshot rule, including any DST effects if applicable. Applies only when a |
| | time_of_day is specified in the snapshot rule. Defaults to UTC if not specified. |
| | Enum: |
| | [Etc/GMT+12, US/Samoa, Etc/GMT+11, America/Atka, US/Hawaii, |
| | Etc/GMT+10, Pacific/Marquesas, US/Alaska, Pacific/Gambier, Etc/GMT+9, |
| | PST8PDT, Pacific/Pitcairn, US/Pacific, Etc/GMT+8, Mexico/BajaSur, |
| | America/Boise, America/Phoenix, MST7MDT, Etc/GMT+7, CST6CDT, |
| | America/Chicago, Canada/Saskatchewan, America/Bahia_Banderas, Etc/GMT+6, |
| | Chile/Easterlsland, America/Bogota, America/New_York,EST5EDT, |
| | America/Havana,Etc/GMT+5,America/Caracas,America/Cuiaba, |
| | America/Santo_Domingo, Canada/Atlantic, America/Asuncion, Etc/GMT+4, |
| | Canada/Newfoundland, Chile/Continental, Brazil/East, America/Godthab, |
| | America/Miquelon, America/Buenos_Aires, Etc/GMT+3, America/Noronha, |
| | Etc/GMT+2, America/Scoresbysund, Atlantic/Cape_Verde, Etc/GMT+1, UTC, |
| | Europe/London, Africa/Casablanca, Atlantic/Reykjavik, Antarctica/Troll, |
| | Europe/Paris, Europe/Sarajevo, Europe/Belgrade, Europe/Rome, Africa/Tunis, |
| | Etc/GMT-1, Asia/Gaza, Europe/Bucharest, Europe/Helsinki, Asia/Beirut, |
| | Africa/Harare, Asia/Damascus, Asia/Amman, Europe/Tiraspol, Asia/Jerusalem, |
| | Etc/GMT-2, Asia/Baghdad, Africa/Asmera, Etc/GMT-3, Asia/Tehran, Asia/Baku, |
| | Etc/GMT-4, Asia/Kabul, Asia/Karachi, Etc/GMT-5, Asia/Kolkata, Asia/Katmandu, |
| | Asia/Almaty, Etc/GMT-6, Asia/Rangoon, Asia/Hovd, Asia/Bangkok, Etc/GMT-7, |
| | Asia/Hong_Kong, Asia/Brunei, Asia/Singapore, Etc/GMT-8, Asia/Pyongyang, |
| | Australia/Eucla, Asia/Seoul, Etc/GMT-9, Australia/Darwin, Australia/Adelaide, |
| | Australia/Sydney,Australia/Brisbane,Asia/Magadan,Etc/GMT-10, |
| | Australia/Lord_Howe,Etc/GMT-11,Asia/Kamchatka,Pacific/Fiji, |
| | Antarctica/South_Pole, Etc/GMT-12, Pacific/Chatham, Pacific/Tongatapu, |
| | Pacific/Apia, Etc/GMT-13, Pacific/Kiritimati, Etc/GMT-14] |

Further, the time zone value database may be kept up-to-date to account for the addition or removal of time zones that follow DST. As long as the time zone value database is kept up-to-date, the snapshot rule (e.g., snapshot rule 500) associated with the first user may continue to be taken at the time of day value (e.g., time of day value 504) specified by the first user and the snapshot rule associated with the second user will continue to be taken at the time of day value specified by the second user even if a transition to or from DST occurs during execution of either snapshot.

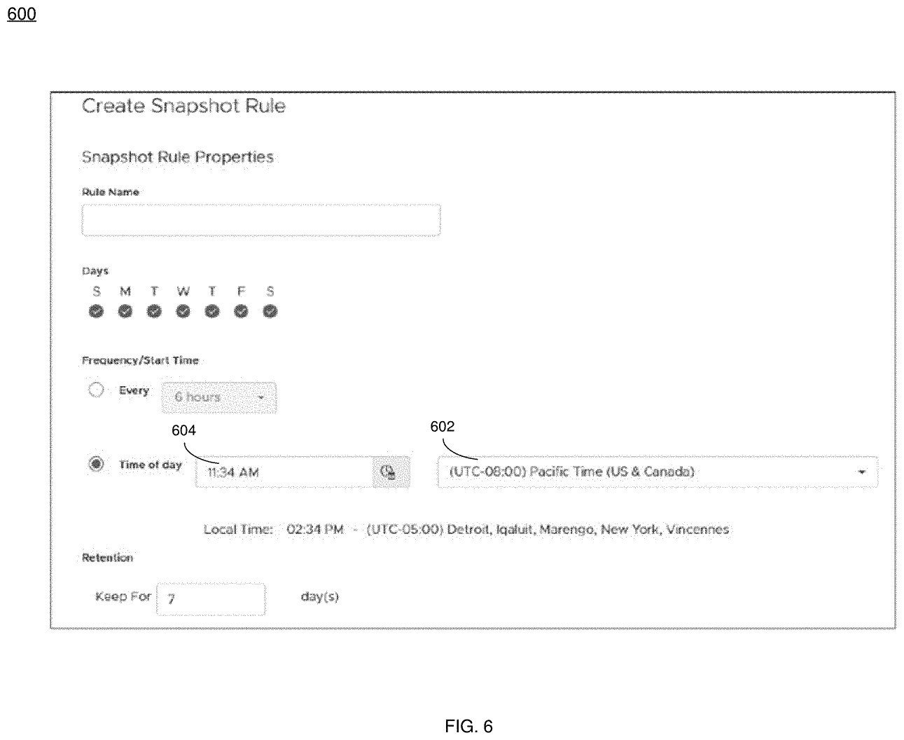

In some embodiments, the first time zone value (e.g., time zone value 502) may be a default time zone value set based on a physical location of a client device associated with the first user (i.e., a local time zone). Alternatively, and referring in more detail to FIG. 6, the first time zone value (e.g., time zone value 602) may be a user-specified time zone. If the user-specified time zone value (e.g., time zone value 602) of the first user is different from the time zone associated with the client device associated with the first user, the time of day value (e.g., time of day value 604) in the local time of the client device associated with the first user may be displayed on the GUI. Further, the default time zone value may be modified before execution of the snapshot rule (e.g., snapshot rule 500) associated with the first user.

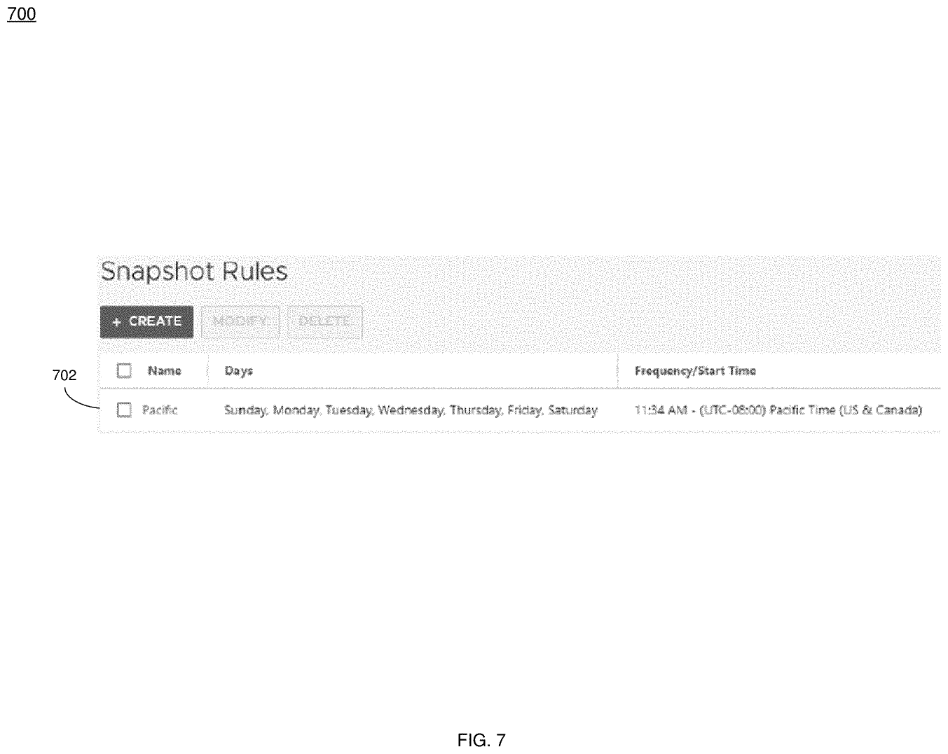

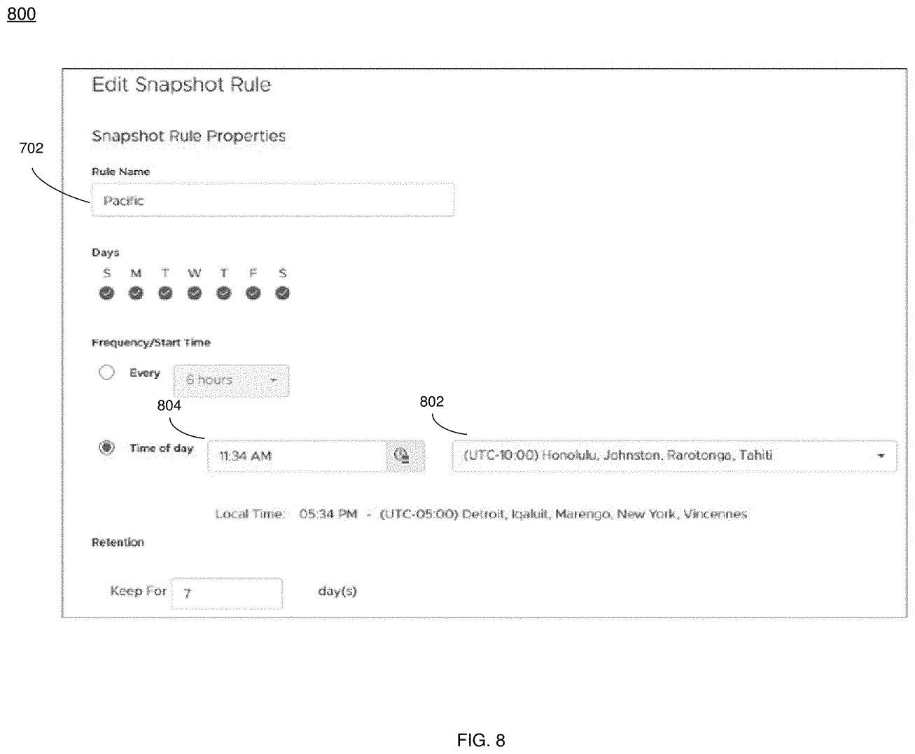

In some embodiments, and referring in more detail to FIGS. 7-8, the first user and/or the second user may wish to modify an existing snapshot rule (e.g., existing snapshot rule 702) associated with each respective user. The first time zone value (e.g., first time zone value 502) may be modified via a client device associated with the first user. The modified first time zone value may be displayed to the first user via the GUI of the client device associated with the first user. The first time zone value (e.g., first time zone value 502) may be different from the time zone of a physical location of the client device associated with the first user. For example, in an existing snapshot rule (e.g., existing snapshot rule 702) denoted as “Pacific” in FIG. 7, a user may have previously specified a time of day value (e.g., time of day value 504) as 11:34 AM with a first time zone value (e.g., first time zone value 502) of ET measured in UTC. When the storage array (e.g., storage array 112) is updated to include time zone value addition process 10, only the time zone value (e.g., first time zone value 502) may need to be changed. Further, when the storage array (e.g., storage array 112) is updated, the time zone value (e.g., time zone value 802) of the existing snapshot rule (e.g., existing snapshot rule 702) may be automatically set to UTC by default in order to maintain an original behavior of the snapshot rule (e.g., existing snapshot rule 702) based on the time zone of the client device associated with a user. However, a user may be able to modify the time of day value (e.g., time of day value 804) and/or the time zone value (e.g., time zone value 802) in that the user may change the time of day value (e.g., time of day value 804) and/or modify the time zone value (e.g., time zone value 802) by selecting a new time zone value from the time zone value list. As mentioned above, the time zone value list may be displayed via a GUI associated with a client device of a user.

In some embodiments, multiple existing snapshot rules (e.g., existing snapshot rule 702) may be associated with a data protection policy that may include replication and/or copying a user's data, a user may have multiple different snapshot rules. A time zone value (e.g., first time zone value 502) may not impact another time zone value with a different time zone value setting even if both are part of a same data protection policy. For example, a data protection policy may be created with a snapshot rule having a time of day value of 2 AM with a time zone value of “US/Pacific” and a second snapshot rule having a time of day value of 2 AM with a time zone value of “American/New_York.” In this configuration, the snapshots will be taken three hours apart. As such, an existing snapshot rule may not impact another existing snapshot rule having different time zone values. Further, time zone value addition process 10 may not interfere with interval-based snapshot rules (e.g., snapshots taken every 5 minutes, 10 minutes, etc.) This may be advantageous in multi-tenant and/or STaaS models.

In some embodiments, time zone value addition process 10 may be applied to additional types of data protection, such as data backup to the cloud and/or backup to DataDomain as developed by Dell EMC of Hopkinton.

In some embodiments, time zone value addition process 10 may be implemented using the API mentioned above and/or using a Command Line Interface (CLI) as shown, respectively, in Table 2 and Table 3 below:

TABLE 2

| Action | Supported | Impact |
|---|---|---|
| GET | Yes | Property can be queried in the normal ways. |
| POST | Yes | Property can be optionally passed to create |
| | | requests. The default is UTC if not supplied. |
| PATCH | Yes | Property can be optionally passed when modifying |
| | | the snapshot rule. The default is to leave the |
| | | timezone unchanged if not supplied. |
| DELETE | No | No impact. |

TABLE 3
Create a “Time of Day” Snapshot Rule
Name = DailySnap
Time of Day = 08:00 in Etc/GMT+7 time zone
Retention = 7 days
pstcli -d localhost snapshot_rule create -name DailySnap -time_of_day “08:00” -timezone
Etc/GMT+7 -
desired_retention 168
Modify a “Time of Day” Snapshot Rule
New Time Zone = Asia/Seoul
pstcli -d localhost snapshot_rule -id 26131eb0-63be-4bl0-85fb-3bf649b7d8el set -timezone
Asia/Seoul
List All Snapshot Rules
pstcli -d localhost snapshot_rule show
# | id | name | interval | time_of_day | timezone | days_of_week | desired_retention | policies.name
----+--------------------------------------+------------+----------+-------------+------------------
+--------------+-------------------+---------------
+++
1 |26131eb0-63be-4bl0-85fb-3bf649b7d8e1 | DailySnap | | 08:00:00+00 | Asia/Seoul | Sunday | 168
|
| | | | | | Monday | |
| | | | | | Tuesday | |
| | | | | | Wednesday | |
| | | | | | Thursday | |
| | | | | | Friday | |
| | | | | | Saturday | |

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

1. A computer-implemented method comprising:
receiving, via a computing device, a snapshot rule associated with a storage array storing a first coded data from a first user with a first time zone value;
receiving, via the computing device, a snapshot rule associated with the storage array storing a second coded data from a second user with a second time zone value, wherein the first time zone value, the second time zone value, and a time zone value associated with a physical location of the storage array are all different;
executing, in response to receiving the snapshot rule associated with the storage array from the second user with a second time zone value, the snapshot rule of the first user and the snapshot rule of the second user;
storing the first time zone value and a first time of day value in the snapshot rule of the first user;
storing the second time zone value and a second time of day value in the snapshot rule of the second user; and
creating a data protection policy which includes replicating the first coded data and the second coded data with the snapshot rule of the first user and the snapshot rule of the second user, respectively.

2. The computer-implemented method of claim 1, wherein executing the snapshot rule of the first user is configured to account for a transition to daylight savings time in the first time zone value during the execution of the snapshot rule.

3. The computer-implemented method of claim 1, wherein executing the snapshot rule of the first user is configured to account for a transition from daylight savings time to the first time zone value during the execution of the snapshot rule.

4. The computer-implemented method of claim 1, wherein one or more of the first time zone value and the second time zone value are chosen from a time zone database, wherein the time zone database is kept up-to-date.

5. The computer-implemented method of claim 1, wherein the first time zone value is a default value set based on a physical location of a client device associated with the first user.

6. The computer-implemented method of claim 5, further comprising modifying, via a client device associated with the first user, the default time zone value before executing the snapshot rule associated with the first user.

7. The computer-implemented method of claim 1 further comprising:
modifying, via a client device associated with the first user, the first time zone value associated with the first user; and
displaying the modified first time zone value, via a graphical user interface of the client device associated with the first user, to the first user, wherein the modified first time zone value is different from a time zone of a physical location of a client device associated with the first user.

8. A computer program product residing on a non-transitory computer readable storage medium having a plurality of instructions stored thereon which, when executed across one or more processors, causes at least a portion of the one or more processors to perform operations comprising:
receiving a snapshot rule associated with a storage array storing a first coded data from a first user with a first time zone value;
receiving a snapshot rule associated with the storage array storing a second coded data from a second user with a second time zone value, wherein the first time zone value, the second time zone value, and a time zone value associated with a physical location of the storage array are all different;
executing, in response to receiving the snapshot rule associated with the storage array from the second user with a second time zone value, the snapshot rule of the first user and the snapshot rule of the second user;
storing the first time zone value and a first time of day value in the snapshot rule of the first user;
storing the second time zone value and a second time of day value in the snapshot rule of the second user; and
creating a data protection policy which includes replicating the first coded data and the second coded data with the snapshot rule of the first user and the snapshot rule of the second user, respectively.

9. The computer program product of claim 8, wherein executing the snapshot rule of the first user is configured to account for a transition to daylight savings time in the first time zone value during the execution of the snapshot rule.

10. The computer program product of claim 8, wherein executing the snapshot rule of the first user is configured to account for a transition from daylight savings time to the first time zone value during the execution of the snapshot rule.

11. The computer program product of claim 8, wherein one or more of the first time zone value and the second time zone value are chosen from a time zone database, wherein the time zone database is kept up-to-date.

12. The computer program product of claim 8, wherein the first time zone value is a default value set based on a physical location of a client device associated with the first user.

13. The computer program product of claim 12, further comprising modifying, via a client device associated with the first user, the default time zone value before executing the snapshot rule associated with the first user.

14. The computer program product of claim 8 further comprising:
modifying, via a client device associated with the first user, the first time zone value associated with the first user; and
displaying the modified first time zone value, via a graphical user interface of the client device associated with the first user, to the first user, wherein the modified first time zone value is different from a time zone of a physical location of a client device associated with the first user.

15. A computing system comprising:
a memory; and
a processor, wherein the processor is configured to:
receive a snapshot rule associated with a storage array storing a first coded data from a first user with a first time zone value;
receive a snapshot rule associated with the storage array storing a second coded data from a second user with a second time zone value, wherein the first time zone value, the second time zone value, and a time zone value associated with a physical location of the storage array are all different;
execute, in response to receiving the snapshot rule associated with the storage array from the second user with a second time zone value, the snapshot rule of the first user and the snapshot rule of the second user;
store the first time zone value and a first time of day value in the snapshot rule of the first user;
store the second time zone value and a second time of day value in the snapshot rule of the second user; and
create a data protection policy which includes replicating the first coded data and the second coded data with the snapshot rule of the first user and the snapshot rule of the second user, respectively.

16. The computing system of claim 15, wherein executing the snapshot rule of the first user is configured to account for a transition to daylight savings time in the first time zone value during the execution of the snapshot rule.

17. The computing system of claim 15, wherein executing the snapshot rule of the first user is configured to account for a transition from daylight savings time to the first time zone value during the execution of the snapshot rule.

18. The computing system of claim 15, wherein one or more of the first time zone value and the second time zone value are chosen from a time zone database, wherein the time zone database is kept up-to-date.

19. The computing system of claim 15, wherein the first time zone value is a default value set based on a physical location of a client device associated with the first user.

20. The computing system of claim 19, wherein the processor is further configured to modify, via a client device associated with the first user, the default time zone value before executing the snapshot rule associated with the first user.

21. The computing system of claim 15, wherein the processor is further configured to:
modify, via a client device associated with the first user, the first time zone value associated with the first user; and
display the modified first time zone value to the first user, wherein the modified first time zone value is different from a time zone of a physical location of a client device associated with the first user.
